(19) United States
(12) Patent Application Publication
(10) Pub. No.: US 2023/0118985 A1
(43) Pub. Date: Apr. 20, 2023

(54) DETERMINING DESIGN DATA FOR A JIG

(71) Applicant: Hewlett-Packard Development Company, L.P., Spring, TX (US)

(72) Inventors: Jorge Diosdado Borrego, Sant Cugat del Valles (ES); Marc Garcia Grau, Sant Cugat del Valles (ES); Sergio Puigardeu Aramendia, Sant Cugat del Vallès (ES)

(21) Appl. No.: 17/505,197

(22) Filed: Oct. 19, 2021

(51) Int. Cl. B22F 10/80; B33Y 50/00; B33Y 80/00; B08B 5/02; B22F 10/68; B33Y 40/20

(52) U.S. Cl. CPC B22F 10/80; B33Y 50/00; B33Y 80/00; B08B 5/02; B22F 10/68; B33Y 40/20

(57) ABSTRACT

A computer-implemented method is disclosed. The method comprises receiving object data relating to a three-dimensional object generated or to be generated using an additive manufacturing apparatus, the object data including details of an aperture in a surface of the three-dimensional object; determining, based on the object data, design data for a jig to engage the object and to form a fluid communication channel between the aperture in the surface of the three-dimensional object and an interface of an airflow control mechanism, the airflow control mechanism to cause a flow of air through the aperture; and providing the design data for delivery to an additive manufacturing apparatus to generate the jig. A jig is also disclosed.

### BACKGROUND

Additive manufacturing systems can be used to generate three-dimensional objects on a layer-by-layer, for example by causing the solidification of some parts of successive layers of build material.

Part of an additive manufacturing process may involve “de-caking” the three-dimensional object, whereby build material that is not solidified and does not form part of the object is removed, for example using vibration techniques and/or by directing a flow of air towards the three-dimensional object.

### BRIEF DESCRIPTION OF DRAWINGS

Examples will now be described, by way of non-limiting example, with reference to the accompanying drawings, in which:

FIG. 1 is a flowchart of an example of a method for determining design data for a jig;

FIG. 2 is a flowchart of a further example of a method for determining design data for a jig

FIG. 3 is a schematic illustration of an example of a jig;

FIG. 4 is a schematic illustration of a further example of a jig;

FIG. 5 is a schematic illustration of a further example of a jig;

FIG. 6 is a flowchart of an example of a method for generating airflow through a three-dimensional object; and

FIG. 7 is a flowchart of a further example of a method for generating airflow through a three-dimensional object.

### DETAILED DESCRIPTION

Additive manufacturing techniques may generate a three-dimensional object through the solidification of a build material. In some examples, the build material may be a powder-like granular material, which may for example be a plastic, ceramic or metal powder. The properties of generated objects may depend on the type of build material and the type of solidification mechanism used. Build material may be deposited, for example on a print bed and processed layer by layer, for example within a fabrication chamber. According to one example, a suitable build material may be PA12 build material commercially known as V1R10A “HP PA12” available from HP Inc, or a metallic build material, for example.

In some examples, selective solidification is achieved through directional application of energy, for example using a laser or electron beam which results in solidification of build material where the directional energy is applied. In other examples, print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material coalesces and solidifies to form a slice of the three-dimensional object in accordance with the pattern.

According to one example, a suitable fusing agent may be an ink-type formulation comprising carbon black, such as, for example, the fusing agent formulation commercially known as V1Q60A “HP fusing agent” available from HP Inc. In one example such a fusing agent may additionally comprise an infra-red light absorber. In one example such a fusing agent may additionally comprise a near infra-red light absorber. In one example such a fusing agent may additionally comprise a visible light absorber. In one example such a fusing agent may additionally comprise a UV light absorber. Examples of print agents comprising visible light enhancers are dye based colored ink and pigment based colored ink, such as inks commercially known as CE039A and CE042A available from HP Inc.

In other examples, coalescence may be achieved in some other manner.

In addition to a fusing agent, in some examples, a print agent may comprise a coalescence modifying agent (referred to as modifying or detailing agents herein after), which acts to modify the effects of a fusing agent for example by reducing or increasing coalescence or to assist in producing a particular finish or appearance to an object, and such agents may therefore be termed detailing agents. A detailing agent (also termed a “coalescence modifier agent” or “coalescing modifier agent”) may, in some examples, have a cooling effect. In some examples, the detailing agent may be used near edge surfaces of an object being printed. According to one example, a suitable detailing agent may be a formulation commercially known as V1Q61A “HP detailing agent” available from HP Inc. A coloring agent, for example comprising a dye or colorant, may in some examples be used as a fusing agent or a modifying agent, and/or as a print agent to provide a particular color for the object. While, in some examples, various agents as discussed above may be used with plastics build material, in other examples, binding agent (sometimes referred to as binder) may be used with metallic build material.

As noted above, additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system.

Once layers of build material have been caused to solidify or coalesce, the resulting part/three-dimensional object may be processed further, for example to remove any non-solidified powder, and to clean the object.

In other additive manufacturing techniques, such as techniques involving metallic build material, binder agent may be applied to successive layers of build material to define a shape of a three-dimensional object to be formed. The volume (i.e., layers) of build material may then undergo a curing process in which the build material is heated to a temperature exceeding the curing temperature of the binder agent for a sufficient duration thereby curing the binder agent. The resulting part following the curing process (sometimes referred to as a “green part”) may comprise a loosely bound matrix of particles of build material and cured binder agent. The green part may then undergo a “de-caking” process, which involves removing any loose, residual build material from the object/green part, discussed in greater detail below. Following the de-caking/cleaning process, the de-caked green part may be sintered in a furnace to form a highly dense, stronger metal object.

In some examples, the de-caking process may be performed in two stages: a coarse de-caking stage and a fine de-caking stage. The course de-caking stage is intended to remove large amounts of build material, and this may be achieved using vibration techniques, laminar flows, and the like. The fine de-caking stage, sometimes referred to as fine cleaning, is intended to remove any remaining build material that is not part of the green part. Fine de-caking may be achieved by blowing clean air towards and around the green part in different directions and at different velocities.

The green part may be fragile, may have low mechanical strength and, therefore, may be damaged easily if not handled carefully. Thus, it can be difficult to remove all of the loose build material from the green part, particularly if the green part includes cavities, channels and/or regions inside, where build material may accumulate, and which are difficult to access using a flow of air from a de-caking device. The present disclosure provides a mechanism by which such internal regions can be cleaned (e.g. by the removal of loose build material) more effectively, in such a way that the likelihood of damaging the green part is low.

Various examples disclosed herein relate to jigs, and methods for determining design data for such jigs. A jig may be used to engage with and/or support an object in an intended position and/or orientation, for example while a task is performed in respect of the object. In examples disclosed herein, a jig may be used with (e.g. to engage and/or support) a three-dimensional object generated during an additive manufacturing process to aid with cleaning the object. Each jig disclosed herein may itself be generated using an additive manufacturing apparatus and the design of each jig may be based on the three-dimensional object with which the jig is to be used.

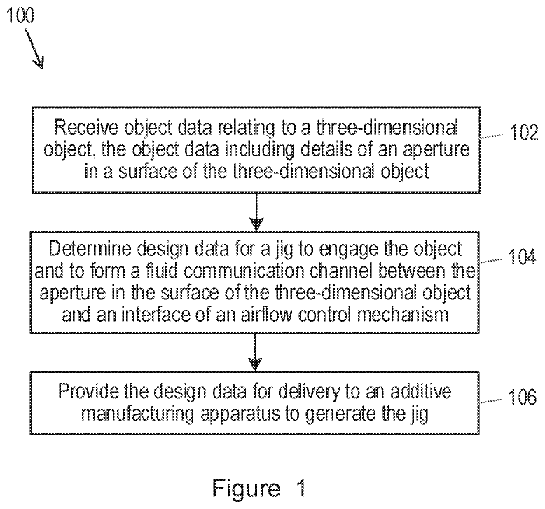

Referring to the drawings, FIG. 1 is a flowchart of an example of a method 100. The method 100, which may comprise a computer implemented method, may be referred to as a method for determining design data for a jig. The method 100 comprises, at block 102, receiving object data relating to a three-dimensional object generated or to be generated using an additive manufacturing apparatus. The object data may be referred to as structural design data for the three-dimensional object, and this may be used by the additive manufacturing apparatus to generate the three-dimensional object, layer by layer, as discussed above. The object data includes details of an aperture in a surface of the three-dimensional object. The aperture, such as a hole in the surface, may comprise an opening to a cavity, recess, void, channel, pipe or the like within the three-dimensional object.

The object data is used in the method 100 to design a jig capable of connecting the three-dimensional object (i.e. a three-dimensional object generated according to the object data) to an airflow source. Thus, at block 102, the method comprises determining, based on the object data, design data for a jig to engage the object and to form a fluid communication channel between the aperture in the surface of the three-dimensional object and an interface of an airflow control mechanism, the airflow control mechanism to cause a flow of air through the aperture. By designing the jig using the object data used to generate the three-dimensional object, the resulting jig may be considered bespoke, such that it fits the three-dimensional object with which it is to be used.

An airflow control mechanism may provide a source of air, such as a flow of air, and may for example form part of a de-caking device. Such an airflow control mechanism may have an outlet (sometimes referred to as an interface) or multiple outlets/interfaces through which air can be provided, for example to be directed towards a three-dimensional object as part of a de-caking process. However, the outlet or outlets may be in a location that does not align with an aperture or apertures in the surface of the three-dimensional object. Therefore, the jig for which design data is determined at block 102, is intended to connect an outlet/interface of the airflow control mechanism with an aperture in the three-dimensional object such that flow of air can be established between the airflow control mechanism and the three-dimensional object, via the aperture.

At step 106, the method 100 comprises providing the design data for delivery to an additive manufacturing apparatus to generate the jig. For example, the design data may be provided in the form of a file, readable and/or executable using a processor of the additive manufacturing apparatus, such that the additive manufacturing apparatus is able to generate the jig using a technique such as those discussed herein.

Blocks of the methods disclosed herein may be performed using a processor or processors, such as a processor of a computing device or computing system. In some examples, different blocks of the methods may be performed using different processors. In some examples, the methods may be performed using a processor of an additive manufacturing apparatus.

The object data relating to the three-dimensional object may comprise data in a format that can be read and/or executed using a process of an additive Manufacturing apparatus. For example, the object data may comprise object data in a format selected from a group comprising: a computer-aided design (CAD) format, an additive manufacturing file format, a 3D manufacturing format (e.g., 3MF), a Standard Tessellation Language format (e.g., STL), an image format (e.g., JPG) and a three-dimensional image format (e.g., OBJ).

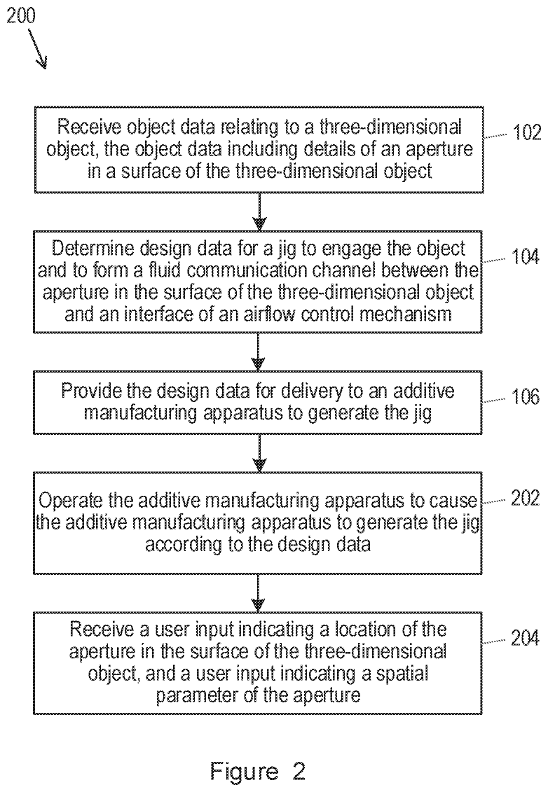

FIG. 2 is a flowchart of a further example of a method 200, such as a method for determining design data for a jig. The method 200 may comprise a block or blocks of the method 100 discussed above. The method 200 may comprise, at block 202, operating the additive manufacturing apparatus to cause the additive manufacturing apparatus to generate the jig according to the design data. Once a jig has been generated according to the methods disclosed herein, the jig can be used in a de-caking/cleaning process for one or multiple three-dimensional objects generated according to the object data. Thus, the present disclosure provides a convenient way of creating a bespoke jig for a particular three-dimensional object, which can be generated relatively quickly and for a relatively low cost. In some examples, a jig may be designed such that it can engage, operate with and/or function with multiple three-dimensional objects, such that multiple three-dimensional objects can be positioned in, against or relative to the jig and processed (e.g., de-caked) at the same time, in a batch-like process.

Various techniques may be used for determining the design data for the jig. In some examples, determining the design data may be achieved with some input from an operator or user (e.g. a partially-automated approach) while, in other examples, the design data may be determined in an automated manner by a computing system (e.g. a processor).

In the partially-automated approach for determining design data, a user may provide an indication of a location of each aperture in the surface of the object. For example, the user may indicate the aperture location(s) on a CAD model of the three-dimensional object. In addition to indicating the location of each aperture, the user may also indicate a direction into the three-dimensional object that the channel or cavity extends. This way, airflow can be directed in an appropriate direction into the three-dimensional object, to cause the intended flow of air and, therefore, the intended dislocation of loose build material within the object. Thus, at block 204, the method 200 may further comprise receiving, via a user interface, a user input indicating a location of the aperture in the surface of the three-dimensional object, and a user input indicating a spatial parameter of the aperture. For example, the spatial parameter may include a direction normal to the surface of the three-dimensional object having the aperture, a shape of the aperture and/or an orientation of the aperture. The direction normal to the surface of the three-dimensional object in which the aperture is located may be considered to be a reasonable approximation of the direction into the three-dimensional object in which the channel or cavity extends. In other examples, however, the user may indicate the direction in which the channel cavity extends into the three-dimensional object. The design data for the jig may be determined based on the received user input. For example, the jig may be designed to have an interface at a position corresponding to the location of each aperture in the three-dimensional object.

In an example which may be partially-automated or fully-automated, the design data for the jig may be determined by combining a plurality of jig components. Each jig component may be considered to be a building block, and the jig components may be coupled or connected together to form a jig having an intended structure. In a partially-automated approach, a user may select a jig component or multiple jig components from a plurality of jig components, and arrange the two components in such a way that appropriate connections can be made between each aperture of the three-dimensional object and an interface of the airflow control mechanism. In some examples, the jig components may comprise jig pipe components, which can be used to enable the fluid connections between the three-dimensional object and the airflow control mechanism to be made. Thus, in such examples, determining the design data for the jig may comprise selecting a jig pipe component from a plurality of jig pipe components based on the object data. For example, jig components, such as jig pipe components, may be selected from a database, or a predetermined library of components. In a fully-automated approach, the selection of jig pipe components may be made using a processor, without an input from a user.

In another example of a fully-automated approach, the design data for the jig may be determined using a processor, based on the object data relating to the three-dimensional object. In this example, the processor may start with an initial volume within which the jig is to be designed, and various regions within the volume may be eliminated or removed based on the object data relating to the three-dimensional object. The portion of the volume that remains may form the basis of the jig. In this example, determining the design data for the jig may comprise defining a solid volume within which to the three-dimensional object can fit. The process then involves determining a negative of the three-dimensional object, and eliminating from the solid volume a region corresponding to the negative of the three-dimensional object. This may involve determining the volume of the three-dimensional object and “subtracting” the three-dimensional objects volume from the initial volume of the jig.

The process then involves eliminating from the solid volume any regions corresponding to regions within the perimeter of the three-dimensional object. This takes account of any “floating bodies” that are within the perimeter of the three-dimensional object and that are not to form part of the jig. Next, air inlets and outlets are designed that can form an interface between the jig and each amateur in the three-dimensional object and between the jig and the airflow control mechanism. Thus, the process involves determining first interface design data for an interface between the jig and the aperture in the surface of the object; and determining second interface design data for an interface between the jig and the interface of the airflow control mechanism. A jig designed in this manner is bespoke to the three-dimensional object. In some examples, the jig may be designed such that it fully surrounds or encloses the three-dimensional object while, in other examples, the jig may engage all sides of the three-dimensional object without fully surrounding the three-dimensional object, or the jig may engage sides of the three-dimensional object.

The three-dimensional object generated or to be generated using the additive manufacturing apparatus, and for which the jig is to be designed, may have one aperture or multiple apertures. Each aperture may form the opening of a tube, a cavity, a recess or a channel within the three-dimensional object and, in some examples, a channel within the three-dimensional object may extend between two apertures, for example from one side of the three-dimensional object to another side of the three-dimensional object. Thus, the object data may include details of a first aperture and a second aperture in a surface of the three-dimensional object. Determining the design data for the jig may comprise determining an airflow path through the three-dimensional object, between the first aperture and the second aperture. In some examples, an airflow path through the three-dimensional object may extend between more than two apertures; in such examples, determining the airflow path may involve determining a path that enables a flow of air via all apertures.

Determining the design data for the jig may comprise determining first interface design data for an interface between the jig and the first aperture; and determining second interface design data for an interface between the jig and the interface of the airflow control mechanism. The first interface and second interface design data therefore enable the determination of design data that can allow air to flow between the first aperture and an airflow control mechanism (e.g. an air source such as a pump or a vacuum source), through the jig. In other examples, determining the design data for the jig may further comprise determining interface design data for an interface between the jig and the second amateur, and determining interface design data for an interface between the jig and the interface of an airflow control mechanism, such that air is able to flow between the airflow control mechanism and the second aperture, through the jig.

As noted above, some or all of the blocks of the methods 100, 200 disclosed herein may be performed using a processor or multiple processors. According to an example, a machine-readable medium may comprise instructions which, when executed by a processor, cause the processor to perform a block or blocks of the methods 100, 200. For example, the machine-readable medium may comprise instructions which, when executed by a processor, cause the processor to receive an indication of a position of an opening of a channel formed within a three-dimensional object; generate model data including parameters of a support structure, the support structure having a duct formed therethrough to provide a passage for a flow of air between the opening and an air flow generator; and provide the model data for delivery to an additive manufacturing apparatus to generate the support structure. The support structure in this example may comprise or be similar to the jig discussed above.

The support structure or jig may be generated using known additive manufacturing technology. In examples where the jig is formed using metallic build material, using techniques described herein, the jig may undergo a sintering stage, in which the de-caked/cleaned green part is heated in a furnace to strengthen the jig, prior to the jig being used.

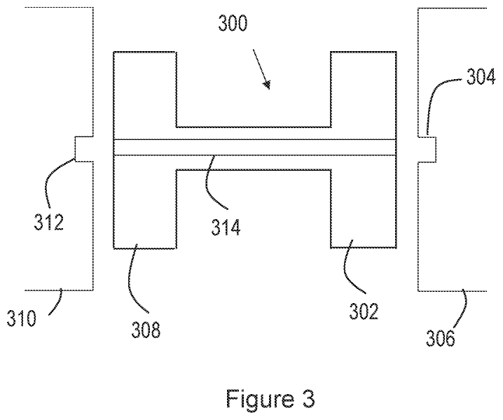

The present disclosure also provides a jig, such as a jig formed using an additive manufacturing apparatus according to the design data discussed herein. FIG. 3 is a schematic illustration of an example of a jig 300. The jig 300 is formed using an additive manufacturing apparatus, and may be generated based on or using the design data determined according to the methods disclosed herein. The jig 300 comprises a first object interface 302 to form a fluid interface with a first opening 304 in a surface of a three-dimensional product 306 of an additive manufacturing process. The three-dimensional product 306 of the additive manufacturing process may, for example, comprise the three-dimensional object discussed herein, with which the jig is intended to be used. The first object interface 302 may comprise a part of the jig 300 that is arranged to interface with (e.g., abut, engage, connect with, and/or form a fluid passage with) the first opening 304.

The jig 300 further comprises a first airflow source interface 308 to form a fluid interface with an airflow source 310 capable of creating a flow of air through the jig. For example, the first airflow source interface 308 may be arranged to interface with an input/output 312 of the airflow source 310. The input/output 312 of the airflow source 310 may be arranged to direct air out of the airflow source or receive air into the airflow source depending on the nature of the airflow source itself. As discussed below, the airflow source 310 may comprise a device arranged to pump or blow air out of the airflow source towards the jig 300 and, in this case, the input/output 312 may be referred to as an output (e.g. an air output). In other examples, the airflow source 310 may comprise a device arranged to suck air out of the jig 300 and into the airflow source and, in this case, the input/output 312 may be referred to as an input (e.g. an air input).

The jig 300 further comprises a first conduit 314 to guide the flow of air between the first object interface 302 and the first airflow source interface 308. The first object interface 302 may comprise a first end of the first conduit 314 and the first airflow source interface 310 may comprise a second end of the conduit 314. Thus, when the jig 300 is positioned appropriately relative to the three-dimensional product 306 and the airflow source 310, a fluid passage is formed between the first opening 304 and the input/output 312 of the airflow source 310, via the conduit 314 in the jig, and air can be directed (e.g. blown or sucked) through the fluid passage in order to displace loose build material within the three-dimensional product.

The first airflow source 310, which may comprise or be the same as the airflow control mechanism discussed above, may comprise an airflow source selected from a group comprising: a vacuum pump; a fan; a compressed air source; and a pneumatic pump. For example, the first airflow source 310 may comprise any component capable of causing a flow of air through the jig 300 and at least partially within the three-dimensional product 306.

In the example shown in FIG. 3, the jig 300 includes one conduit 314 enabling a fluid passage to be created between the first opening 304 in the surface of the three-dimensional product 306 and the input/output 312 of the airflow source 310. In other examples, the jig 300 may include components enabling more fluid passages to be created.

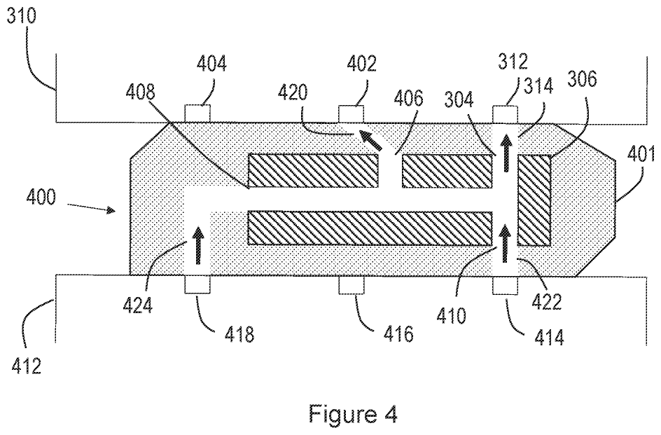

FIG. 4 is a schematic illustration of a further example of a jig 400. The jig 400 is shown positioned between the first airflow source 310 and a second airflow source 412. The three-dimensional product 306 (e.g. a three-dimensional object generated using additive manufacturing techniques), shown in FIG. 4 with hatching, is located within the jig 400. As in the example shown in FIG. 4, the jig 400 may, in some examples, comprise a housing 401 to at least partially enclose the three-dimensional product 306, the housing having a housing wall. The first conduit 314 is formed through the housing wall.

In some examples, the first airflow source 310 may comprise an air source or a device capable of generating an airflow, such as a fan or a pump, and the second airflow source 412 may comprise a sink or airflow sink, which receives the air and causes the air to be extracted, along with any loose build material that is displaced from the three-dimensional object.

In the jig 400, the conduit 314 extends between the first opening 304 and the input/output 312. The first airflow source 310 includes a first input/output 312 and the three-dimensional product 306 has a first opening 304 formed in its surface. In the example shown in FIG. 4, the first airflow source 310 includes a second input/output 402 and a third input/output 404, and the three-dimensional product 306 includes a second opening 406, a third opening 408 and a fourth opening 410. The example shown in FIG. 4 also includes a second airflow source 412 having 3 inputs/outputs, 414, 416 and 418.

Thus, according to the example shown in FIG. 4, the jig 400 comprises a second object interface to form a fluid interface with the second opening in a surface of the three-dimensional product 306; a second airflow source interface to form a fluid interface with an airflow source 310 capable of creating a flow of air through the jig 400; and a second conduit 420 to guide the flow of air between the second object interface and the second airflow source interface.

In some examples, the second airflow source interface of the jig 400 may include a fluid interface with a different airflow source, such as the second airflow source 412. In such examples, the flow of air may be caused to flow between the first object interface and the second object interface of the jig 400 through a channel formed through the three-dimensional product 306. For example, a channel may be formed between the first opening 304 and the fourth opening 410 in the example of FIG. 4.

In the jig 400 shown in FIG. 4, multiple channels are formed within the three-dimensional product 306 between the openings 304, 406, 408 and 410. In addition to the first conduit 314 and the second conduit 420, a third conduit 422 is formed in the jig 400 between an interface at the fourth opening 410 and the input/output 414 of the second airflow source 412, and a fourth conduit 424 is formed in the jig between an interface at the third opening 408 and the input/output 418 of the second airflow source.

In this example, the first airflow source 310 may comprise a vacuum source, or a component capable of sucking air, and the second airflow source 412 may comprise a component capable of blowing air, such as a pump. In this way, in use, a flow of air may be directed from the second airflow source 412 and extracted by the first airflow source 310. The air may travel from the inputs/outputs 414, 418 of the second airflow source 412, via the third conduit 422 and the fourth conduit 424 respectively into the channel formed through the three-dimensional product 306. The air may then travel out from the three-dimensional object 306 via the first opening 304 and the second opening 406, and into the input/output 312 the input/output 402 of the first airflow source 310. In some examples, the jig 400, the first and/or second airflow sources and/or openings of the three-dimensional object may be arranged in or relative to a container, receptacle or a box, such that build material that is extracted or removed from the three-dimensional object may be captured.

The design data may be determined such that the flow of air through the three-dimensional product 306 is such that air is able to pass through each channel in the three-dimensional object. In this way, any loose build material that has accumulated within a channel in the three-dimensional product 306 may be displaced (e.g. removed) by the flow of air through the channel.

In some examples, an airflow source (e.g. the first airflow source 310 and/or the second airflow source 412) may have inputs/outputs (e.g. the inputs/outputs 404 and 416) that are not to form a fluid passage with an opening of the three-dimensional product 306. In such examples, an input/output may be provided with a valve (e.g. a pneumatic valve) to restrict or prevent air from flowing into or out from the input/output.

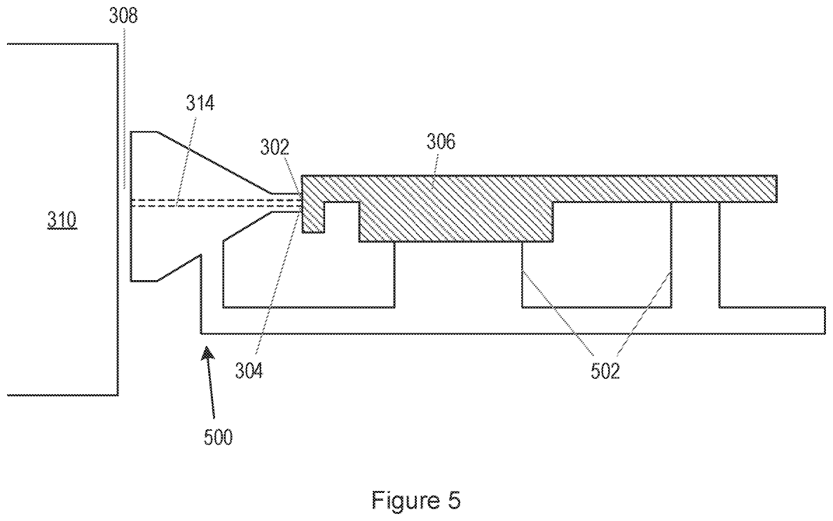

FIG. 5 is an illustration of a further example of a jig 500. In this example, the jig 500 forms an interface with the airflow source 310 at the first airflow source interface 308, and forms an interface with the opening 304 of the three-dimensional product/object 306 at the first object interface 302. The first conduit 314 within the jig 500 is to guide a flow of air between the first object interface 302 and the first airflow source interface 308. In this example, the airflow source 310 may comprise a vacuum source which, in use, may cause air and loose build material that has accumulated within the three-dimensional object 306 to be sucked out and removed.

In some examples, including the example shown in FIG. 5, the jig 500 may comprise a support member 502 to secure the three-dimensional product 306 in such a position that an alignment of the first object interface 302 and the first opening 304 is maintained. In some examples, the jig 500 may comprise multiple support members 502. Each support member 502 may engage a part of the three-dimensional product 306 so as to hold or clamp the three-dimensional product in an intended position, or each support member may provide a support on which the three-dimensional product may rest in the intended position.

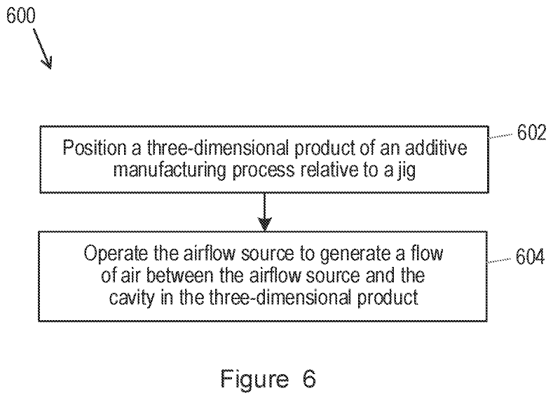

The present disclosure also provides a further method, such as a method for generating a flow of air within the three-dimensional product or object 306. FIG. 6 is a flowchart of an example of a method 600. Some or all of the method 600 may form part of a workflow in which a three-dimensional object 306 can be generated using an additive manufacturing apparatus, and automatically cleaned (e.g. de-caked) using a jig generated in accordance with the present disclosure.

The method 600 comprises, at block 602, positioning a three-dimensional product 306 of an additive manufacturing process relative to a jig 300, 400, 500 as disclosed herein, such that the jig forms a fluid connection between a first opening 304 in a surface of a three-dimensional product and a first airflow source interface 308 of an airflow source 310, wherein the three-dimensional product includes a cavity accessible via the opening. At block 604, the method 600 comprises operating the airflow source 310 to generate a flow of air between the airflow source and the cavity in the three-dimensional product 306.

The blocks 602, 604 of the method 600 may be performed using a processor or multiple processors. Positioning the three-dimensional product 306 relative to the jig 300, 400, 500 may involve a processor operating an apparatus (e.g. robotic apparatus) capable of maneuvering the three-dimensional product into an appropriate position relative to the jig. In this way, fragile three-dimensional objects may be moved in a way that reduces the likelihood of them being damaged. In some examples, multiple three-dimensional products 306 may be arranged (e.g. in a line or an array), and some or all of the three-dimensional products may be positioned in a jig or multiple jigs together. Thus, in some examples, the jig 300, 400, 500 may be arranged to receive multiple three-dimensional products 306.

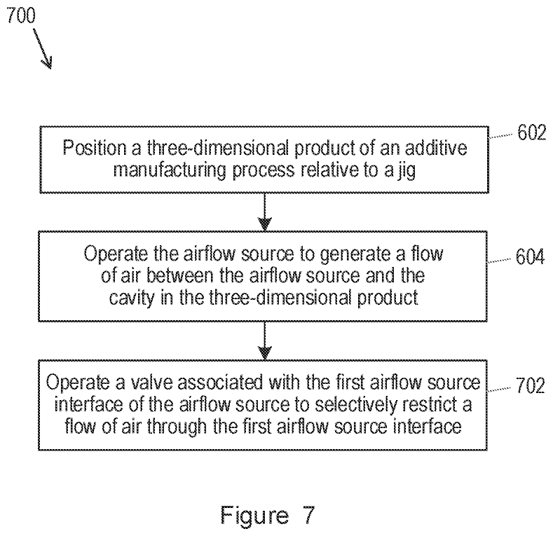

FIG. 7 is a flowchart of a further example of a method 700 which may include a block or blocks of the method 600. The block 700 may comprise, at block 702, operating a valve associated with the first airflow source interface 308 of the airflow source 310 to selectively restrict a flow of air through the first airflow source interface. For example, in the arrangement shown in FIG. 4, where the airflow source 310 includes multiple inputs/outputs, a valve (e.g. a pneumatic valve) may be used to restrict or prevent airflow. Thus, a valve or valves may be used to restrict airflow through an input/output of airflow source having more inputs/outputs than the number of openings in a three-dimensional object with which the airflow source is to be used.

Various parameters may be varied in order to control airflow through the jig and, therefore, through the three-dimensional object. As noted above, a valve may be operated to restrict or prevent airflow through a particular input or output of the airflow source. By operating the valves of the outputs and the valves of the inputs, it is possible to control the flow of air through different channels within the three-dimensional object, thereby enabling an airflow through all of the channels. Some inputs/outputs may be operated in a sequence (e.g. by operating valves in a particular manner) so as to control an order of the air flow through the inputs/outputs. In some examples, a pressure of air flow may be controlled for each input/output.

In some examples, the method 600, 700 may further comprise, prior to block 602, a block relating to the determination of the design data for the jig, such as determining, based on object model data relating to a three-dimensional object generated or to be generated using an additive manufacturing apparatus, design data for a jig to engage the object, wherein the object model data includes details of a cavity in the object accessible via an opening in a surface of the object. The method 600, 700 may, in some examples, further comprise generating, using an additive manufacturing apparatus, a jig based on the design data.

The present disclosure provides a mechanism by which a jig can be designed in a partially-automated or fully-automated manner, wherein the resulting jig can be used as part of a de-caking process to displace loose build material that has accumulated within a cavity of a three-dimensional object. According to the various examples described herein, a jig may enable i) a single negative pressure airflow source, such as a vacuum source, to reduce an air pressure in the three-dimensional object, thereby causing air and loose build material to be sucked out from the three-dimensional object; ii) a single positive pressure airflow source, such as a pump or fan, to force air and loose build material through the three-dimensional object and out of an opening (e.g., an opening at atmospheric pressure); and iii) multiple airflow sources, such as a positive airflow source (e.g., a pump or fan) and a negative airflow source (e.g. a vacuum source) to operate together to move air and loose build material through the three-dimensional object.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A computer-implemented method comprising:
receiving object data relating to a three-dimensional object generated or to be generated using an additive manufacturing apparatus, the object data including details of an aperture in a surface of the three-dimensional object;
determining, based on the object data, design data for a jig to engage the object and to form a fluid communication channel between the aperture in the surface of the three-dimensional object and an interface of an airflow control mechanism, the airflow control mechanism to cause a flow of air through the aperture; and
providing the design data for delivery to an additive manufacturing apparatus to generate the jig.

2. A computer-implemented method according to claim 1, further comprising:
operating the additive manufacturing apparatus to cause the additive manufacturing apparatus to generate the jig according to the design data.

3. A computer-implemented method according to claim 1, further comprising:
receiving, via a user interface, a user input indicating a location of the aperture in the surface of the three-dimensional object, and a user input indicating a spatial parameter of the aperture;
wherein the design data for the jig is determined based on the received user input.

4. A computer-implemented method according to claim 1, wherein determining the design data for the jig comprises selecting a jig pipe component from a plurality of jig pipe components based on the object data.

5. A computer-implemented method according to claim 1, wherein determining the design data for the jig comprises:
defining a solid volume within which to the three-dimensional object can fit;
determining a negative of the three-dimensional object;
eliminating from the solid volume a region corresponding to the negative of the three-dimensional object;
eliminating from the solid volume any regions corresponding to regions within the perimeter of the three-dimensional object;
determining first interface design data for an interface between the jig and the aperture in the surface of the object; and
determining second interface design data for an interface between the jig and the interface of the airflow control mechanism.

6. A computer-implemented method according to claim 1, wherein the object data includes details of a first aperture and a second aperture in a surface of the three-dimensional object; and
wherein determining the design data for the jig comprises:
determining an airflow path through the three-dimensional object, between the first aperture and the second aperture;
determining first interface design data for an interface between the jig and the first aperture; and
determining second interface design data for an interface between the jig and the interface of the airflow control mechanism.

7. A computer-implemented method according to claim 1, wherein the object data comprises object data in a format selected from a group comprising: a computer-aided design, CAD, format, an additive manufacturing file format, a 3D manufacturing format, a Standard Tessellation Language format, an image format and a three-dimensional image format.

8. A jig, formed using an additive manufacturing apparatus, the jig comprising:
a first object interface to form a fluid interface with a first opening in a surface of a three-dimensional product of an additive manufacturing process;
a first airflow source interface to form a fluid interface with an airflow source capable of creating a flow of air through the jig; and
a first conduit to guide the flow of air between the first object interface and the first airflow source interface.

9. A jig according to claim 8, wherein the airflow source comprises an airflow source selected from a group comprising: a vacuum pump; a fan; a compressed air source; and a pneumatic pump.

10. A jig according to claim 8, further comprising:
a second object interface to form a fluid interface with a second opening in a surface of the three-dimensional product;
a second airflow source interface to form a fluid interface with an airflow source capable of creating a flow of air through the jig; and
a second conduit to guide the flow of air between the second object interface and the second airflow source interface.

11. A jig according to claim 10, wherein the flow of air is to flow between the first object interface and the second object interface through a channel formed through the three-dimensional product.

12. A jig according to claim 8, further comprising:
a support member to secure the three-dimensional product in such a position that an alignment of the first object interface and the first opening is maintained.

13. A jig according to claim 8, further comprising:
a housing to at least partially enclose the three-dimensional product, the housing having a housing wall;
wherein the first conduit is formed through the housing wall.

14. A method comprising:
positioning a three-dimensional product of an additive manufacturing process relative to a jig according to claim 8, such that the jig forms a fluid connection between a first opening in a surface of a three-dimensional product and a first airflow source interface of an airflow source, wherein the three-dimensional product includes a cavity accessible via the opening; and
operating the airflow source to generate a flow of air between the airflow source and the cavity in the three-dimensional product.

15. A method according to claim 14, further comprising:
operating a valve associated with the first airflow source interface of the airflow source to selectively restrict a flow of air through the first airflow source interface.
